(19) United States
(12) Patent Application Publication
(10) Pub. No.: US 2018/0245735 A1
(43) Pub. Date: Aug. 30, 2018

(54) HARDWARE ASSEMBLY WITH REVERSIBLE DRY ADHESIVE

(71) Applicant: LIBERTY HARDWARE MFG. CORP., Winston-Salem, NC (US)

(72) Inventors: Earl David FORREST, Asheboro, NC (US); Nathaniel Faltin Dutton SCHULTZ, Charlotte, NC (US)

(21) Appl. No.: 15/630,145

(22) Filed: Jun. 22, 2017

Related U.S. Application Data
(63) Continuation-in-part of application No. 15/442,201, filed on Feb. 24, 2017.

(51) Int. Cl. F16M 13/02; B32B 7/12; B32B 25/08; B32B 7/06; C09J 5/00

(52) U.S. Cl. CPC F16M 13/022; B32B 7/12; C09J 109/06; B32B 7/06; C09J 5/00; B32B 25/08

(57) ABSTRACT

A hardware assembly is provided with a rigid hardware component. A flexible substrate is mounted to the rigid hardware component. A reversible dry adhesive is spread across an application surface of the flexible substrate to mount the hardware assembly to a support surface. The flexible substrate permits compliance between the reversible dry adhesive and the rigid hardware component to minimize nonconformance of the reversible dry adhesive upon the support surface. A method of installing the hardware assembly provides a flexible substrate with a rigid hardware component upon one side of the flexible substrate, and a reversible dry adhesive upon another side of the flexible substrate. The rigid hardware component is pressed towards a support surface to engage the reversible dry adhesive with the support surface while deforming the flexible substrate to minimize nonconformance of the reversible dry adhesive and the support surface.

### CROSS-REFERENCE TO RELATED APPLICATIONS

This application is a continuation-in-part of U.S. application Ser. No. 15/442,201 filed Feb. 24, 2017, now U.S. Pat. No. ______, the disclosure of which is hereby incorporated in its entirety by reference herein.

### TECHNICAL FIELD

Various embodiments relate to hardware assemblies with a reversible dry adhesive.

### BACKGROUND

An application of a reversible dry adhesive for a shower rod assembly is disclosed in U.S. application Ser. No. 14/048,553, filed on Oct. 8, 2013, and issued on Jan. 31, 2017 as U.S. Pat. No. 9,554,674 B2.

### SUMMARY

According to at least one embodiment, a hardware assembly is provided with a rigid hardware component. A flexible substrate is mounted to the rigid hardware component. A reversible dry adhesive is spread across an application surface of the flexible substrate to mount the hardware assembly to a support surface. The flexible substrate permits compliance between the reversible dry adhesive and the rigid hardware component to minimize nonconformance of the reversible dry adhesive upon the support surface.

According to at least another embodiment, a method of manufacturing a hardware assembly forms a flexible substrate. A rigid hardware component is formed upon the flexible substrate. A reversible dry adhesive is provided across an application surface of the flexible substrate.

According to another embodiment, a method of installing a hardware assembly provides a flexible substrate with a rigid hardware component upon one side of the flexible substrate, and a reversible dry adhesive upon another side of the flexible substrate. The rigid hardware component is pressed towards a support surface to engage the reversible dry adhesive with the support surface while deforming the flexible substrate to minimize nonconformance of the reversible dry adhesive and the support surface.

### BRIEF DESCRIPTION OF THE DRAWINGS

FIG. 1 is a side partial section view of a partially assembled hardware assembly according to an embodiment;

FIG. 2 is a side partial section view of an assembled hardware assembly according to an embodiment;

FIG. 3 is an enlarged side partial section view of the hardware assembly of FIG. 2;

FIG. 4 is a side partial section view of the hardware assembly of FIG. 2, illustrated installed upon a support surface;

FIG. 5 is a rear elevation view of the installed hardware assembly of FIG. 4;

FIG. 6 is a side section view of a hardware assembly;

FIG. 7 is an enlarged partial side section view of the hardware assembly of FIG. 6;

FIG. 8 is a side section view of another hardware assembly;

FIG. 9 is a side section view of another hardware assembly according to another embodiment;

FIG. 10 is a side section view of another hardware assembly;

FIG. 11 is a side section view of another hardware assembly according to another embodiment;

FIG. 12 is a side section view of another hardware assembly according to another embodiment;

FIG. 13 is a schematic force diagram of the hardware assembly of FIG. 12 when an air pocket is pulled by an external force in current-state rigid mount products;

FIG. 14 is another schematic force diagram of the hardware assembly of FIG. 12 when full or nearly full conformance exists;

FIG. 15 is a side elevation view of a hardware assembly according to an embodiment;

FIG. 16 is a perspective view of a hardware assembly;

FIG. 17 is a perspective view of a hardware assembly according to an embodiment;

FIG. 18 is a side elevation view of a hardware assembly according to another embodiment;

FIG. 19 is a side elevation view of a hardware assembly according to another embodiment; and

FIG. 20 is a side elevation view of a hardware assembly according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Various embodiments relate to hardware assemblies that are mounted to a substrate, or flat target support surface with a reversible dry adhesive, such as styrene ethylene butylene styrene (SEBS), a silicone-based adhesive, or the like. FIG. 1 schematically illustrates a SEBS adhesive layer 30 and a substrate 32. The substrate 32 is formed from a polymeric material such as polyethylene terephthalate. The adhesive layer 30 and the substrate 32 are illustrated schematically and exaggerated to illustrate a curvature formed in both materials as a result of manufacturing processes. The curvature may be caused by a stamping operation, such as a die cut operation for cutting the adhesive layer 30 and the substrate 32 from a stock material.

FIGS. 2 and 3 illustrate a rigid hardware component, such as a hook 34, bonded to the substrate 32 by a light curable or ultraviolet (UV) curable adhesive 36 to become a hardware assembly 38. FIG. 2 illustrates a light source, by a plurality of UV lamps 40 for curing the UV curable adhesive 36 and bonding the hook 34 to the substrate 32. The hook 34 may be formed from a translucent polymeric material to permit the UV curable adhesive 36 under the hook 34 to cure. Due to the curvature of the substrate 32, the UV curable adhesive 36 has a thickness that varies, such as thicknesses x and y in FIG. 3. This variation in thickness maintains the substrate 32 in a curved formation.

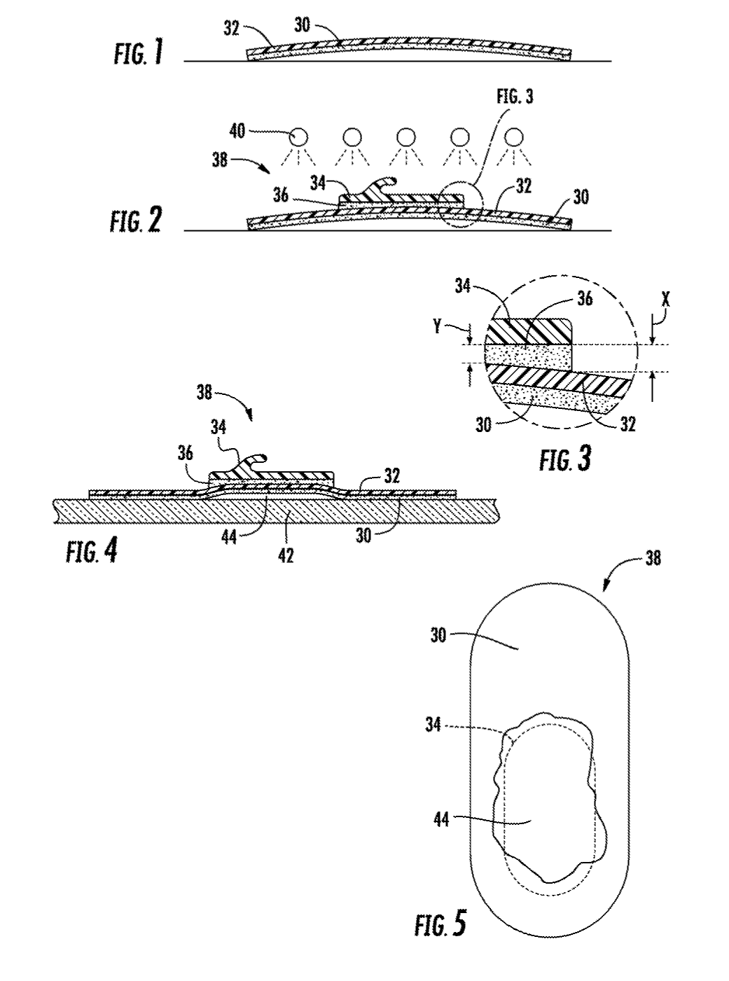

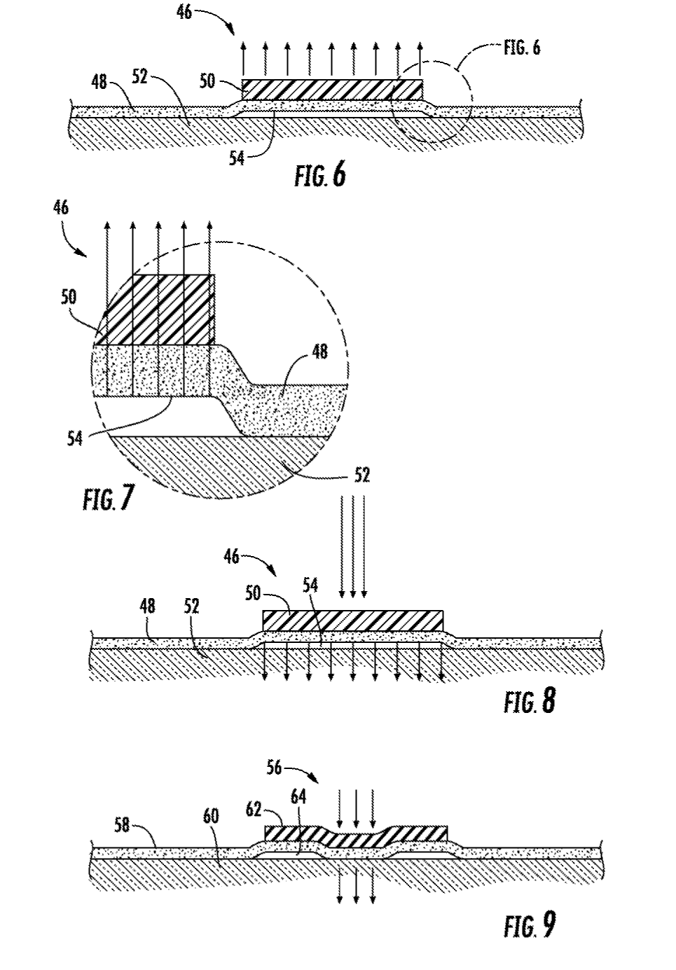

FIG. 4 illustrates the hardware assembly 38 mounted upon a flat support surface 42, such as glass or tile. In FIG. 4, the SEBS adhesive 30 is bonded directly to the support surface 42. Due to the curvature of the substrate 32 and the SEBS adhesive 30, an area of nonconformance, or an air pocket 44, may form between the SEBS adhesive 30 and the support surface 42. FIG. 5 illustrates the installed hardware assembly 38 without the support surface to depict a potential form of the air pocket 44.

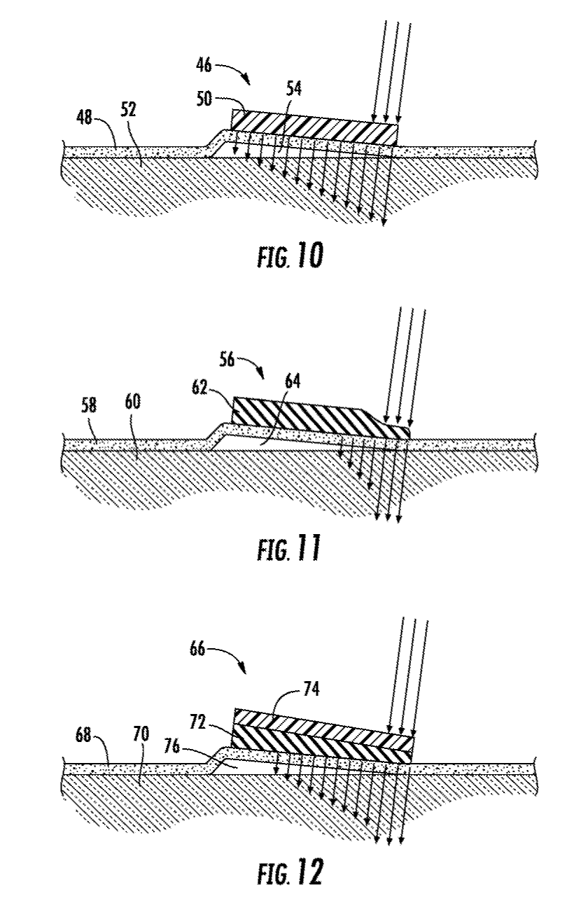

This area of nonconformance 44 is difficult to press out manually, even when following proper installation instructions and procedures. The area of nonconformance 44 is detrimental to the load bearing capacity of the hardware assembly 38. The hardware assembly 38 loses shear strength due to the nonconformance region subtracting from a total potential adhesion area. FIGS. 6 and 7 illustrate a hardware assembly 46 with a SEBS adhesive layer 48 supporting a rigid hardware component 50 upon a support surface 52. FIGS. 6 and 7 illustrate a force distribution upon the rigid hardware component 50. The presence of a nonconformance area 54 causes the SEBS adhesive 48 surrounding the air pocket 54 to be subjected to a peel force. SEBS adhesives 48 are naturally weaker to peel forces. As the SEBS adhesive 48 is peeled from the support surface 52, the total area of conformance will be reduced. This reduction conformance weakens the overall load bearing capacity of the hardware assembly 46 and may cause the SEBS adhesive 48 to fail.

The area of nonconformance created behind the hardware assemblies 38, 46 of SEBS mounted products can be minimized through optimization of material configurations, geometries and/or manufacturing methods and processes. Such minimization can improve the load bearing capabilities of the hardware assemblies 38, 46.

For these hardware assemblies 38, 46, it is common to manufacture the rigid hardware component 34, 50 from a rigid, generally translucent, polymeric material, such as polycarbonate. Polycarbonate is clear, strong and relatively inexpensive. The translucency enhances the overall look of the finished hardware assembly 38, 46 and ensures that the UV light cures the UV adhesive 36 as the light is directed through the rigid hardware component 34, 50 during the curing process. However, when the SEBS adhesive layer 30, 48 is mounted to a rigid material, any region of nonconformance 44, 54 that occurs is difficult to press out during the mounting process.

FIGS. 8 illustrates the hardware assembly 46 during installation of the SEBS adhesive layer 48 upon the support surface 52. Due to the rigidity of the rigid hardware component 50, a force that is applied upon the rigid hardware component 50, is distributed through the hardware assembly 46 evenly at the air pocket 54 between the SEBS adhesive 48 and the support surface 52.

FIGS. 9 illustrates a hardware assembly 56 during installation of a SEBS adhesive layer 58 upon a support surface 60. A flexible substrate 62 is provided upon the SEBS adhesive layer 58. A force applied upon the flexible substrate 62 is directed through an air pocket 64 so that the SEBS adhesive layer 58 contacts the support surface 60. The force is concentrated due to the flexibility of the substrate 62, and is not distributed.

FIG. 9 illustrates when a soft material, such as a material of low durometer hardness such as the flexible substrate 62 is employed. The flexible substrate 62 may be as an intermediate layer between a rigid hardware component and the SEBS adhesive layer 58 according to an embodiment. The flexible substrate 62 may be employed as the hardware mounting component itself. Due to the flexibility of the substrate 62, the area of nonconformance 64 is easier to press out. Since the load forces are distributed throughout the SEBS adhesive layer 58 and the support surface 60 when a material of low durometer is used, the load bearing capabilities of the hardware assembly 56 are improved.

If an area of nonconformance 44, 54, 64 is present behind the mounting component 34, 50, 62, either as a result of the manufacturing process or as a result of the installation process, the user is instructed to press the nonconformance area 44, 54, 64 outwards towards the edges of the SEBS adhesive layer 30, 48, 58 where the air will be released. When the user presses out an air pocket 44, 54, 64 behind the mounting component 34, 50, 62, the force directed from the user's finger will be more concentrated when pressing though a flexible substrate 62 with a lower durometer hardness or more elasticity than a component 34, 50 which is more rigid.

The flexible substrate 62 of FIG. 9 permits the user to apply far less force to create contact between the SEBS adhesive layer 58 and the underlying support surface 60, in contrast from the rigid hardware component 50 of FIG. 8. In the hardware assembly 56 of FIG. 9, the nonconformance area 64 can be pressed outwards towards the edges of the SEBS adhesive layer 58 to release the air pocket 64 and remove the nonconformance.

If the user directs the pressure on one side of the mounting component 50, 62 in an effort to press out the nonconforming area 54, 64, the more ductile flexible substrate 62 is more advantageous as well. FIG. 10 illustrates the hardware assembly 46 with a force applied upon the rigid hardware component 50 on one end at an angle. The force is distributed due to the rigid structure of the hardware component 50, making it difficult for the user to remove the nonconformance area 54.

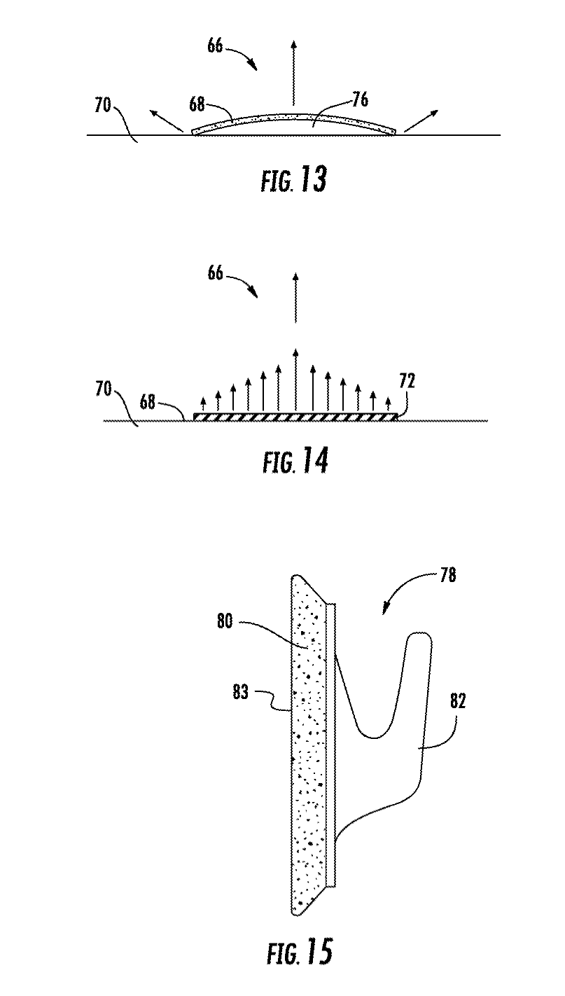

FIG. 11 depicts the hardware assembly 56 a force applied to the flexible substrate 62 at an angle on one end. The force remains concentrated and permits the SEBS adhesive layer 58 to engage the support surface 60. The level of rigidity needed for the mounting component 50, 62 to withstand deformation from loading is dependent on the size and geometry of the mounting component 50, 62 as well as the intended load bearing functionality of the hardware assembly 46, 56.

The hardware assembly 56 of FIGS. 9 and 11 utilizes the flexible substrate from a material with a lower durometer hardness for the mounting component. FIG. 12 illustrates a hardware assembly 66 with a SEBS adhesive layer 68 for mounting to a support surface 70. A flexible substrate 72 is mounted to the SEBS adhesive layer 68. A rigid hardware component 74 is mounted directly to the flexible substrate 72. The flexible substrate 72 has a lower durometer than that of the rigid hardware component 74 to collectively provide a dual durometer mount which combines a more rigid mounting hook 74 bonded to a softer backing portion 72 which provides an interface bond to the SEBS adhesive layer 68. This type of mounting hardware assembly 66 is beneficial when a rigid hardware component 74 is required to avoid excessive deformation under a significant loading applications.

During installation, a force applied to one end of the rigid component 74 is more concentrated for engagement of the SEBS adhesive layer 68 with the support surface 70 for minimizing a nonconformance region or air pocket 76. The concentration of the installation forces is less than that of a purely flexible mounting component 62 of the hardware assembly 56 of FIGS. 9 and 11. However, the concentration is more focused than the even distribution of forces in the rigid hardware component 50 of the hardware assembly 46 of FIGS. 8 and 10.

The elasticity of the lower durometer substrate 72 permits the user to evenly spread the forces from a loaded mounting component 74 throughout the hardware assembly 66. When combined with full conformance of the SEBS adhesive layer 68, this diffusion greatly reduces the potential for the centralized air pocket 76 to develop and spread. The hardware assembly 66 has an additional benefit of spreading a load from a concentrated point on the rigid mounting component 74 to the full surface area common between the softer (low durometer) backing substrate 72 and the SEBS adhesive layer 68. As illustrated schematically in FIG. 13, when the air pocket 76 is pulled by an external force in current-state rigid mount products a centralized load or perpendicular force behind the rigid hardware component 74 which is depicted by the central force arrow, pulls away from the support surface 70 and puts the SEBS adhesive layer 68 into peel as depicted by the lateral pair of force arrows.

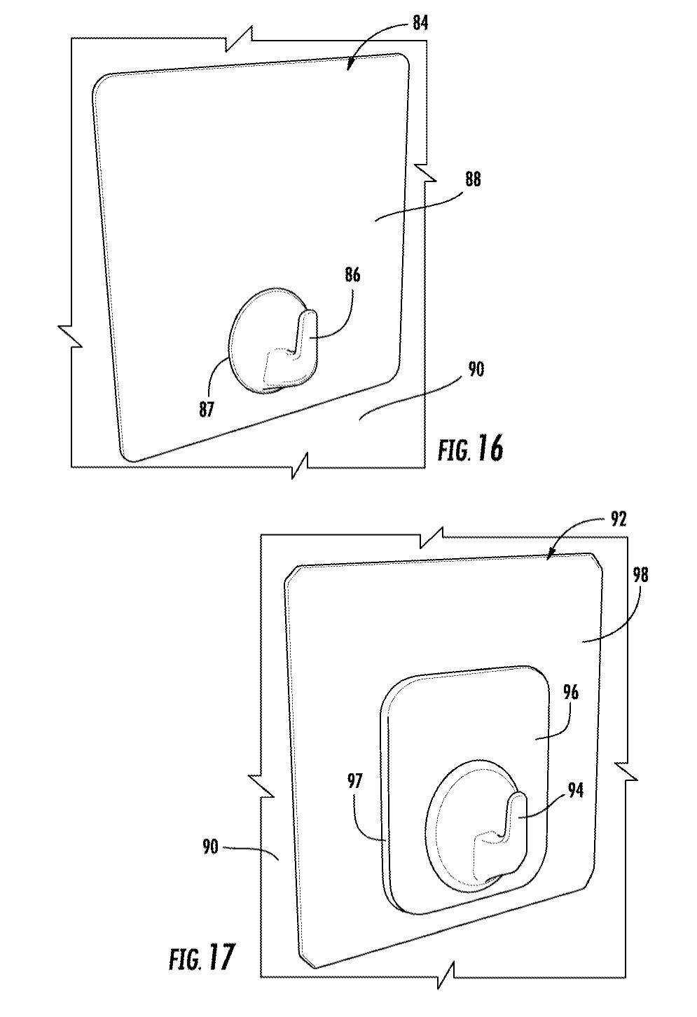

FIG. 14 illustrates a force schematic of the flexible substrate 72 for the hardware assembly 66 in a fully conformed installation with little or no air pocket 76. A peel force is still created on the edges of the low durometer pad 72, but the forces are significantly reduced. A similar force graph would result even if a small nonconformance area 76 was present behind the low durometer material 72, provided that the area is contained within the perimeter of the low durometer mounting component 72.

FIG. 15 illustrates a hardware assembly 78 according to another embodiment. A low durometer backing material 80 is provided between a rigid hook 82 and an adhesive layer 83. The flexible substrate 80 is drafted to create a larger contact area between the low durometer material 72 and the SEBS adhesive layer 68 than the contact area between the flexible substrate 80 and the rigid hardware component 82.

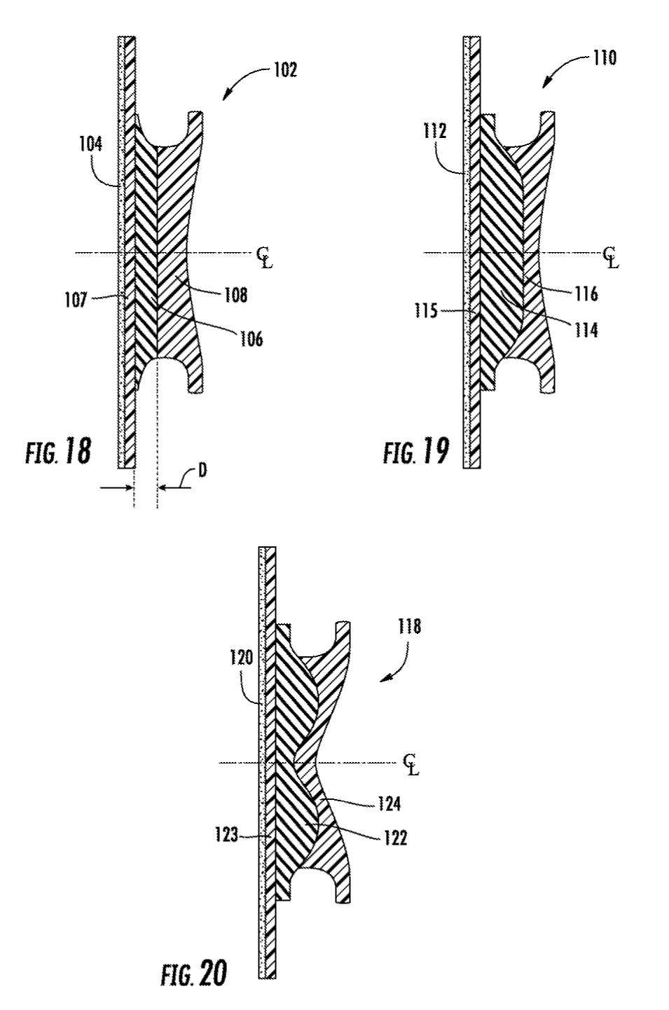

Prototype testing has been performed to contrast a rigid mounted hook to the dual durometer system. FIG. 16 illustrates a hardware assembly 84 with a rigid hook 86 bonded to a polyethylene terephthalate (PET) layer 87, which is then bonded to the dry reversible SEBS adhesive layer 88 with an adhesion promoter. The SEBS layer 88 is mounted to a flat support surface 90. FIG. 17 illustrates another hardware assembly 92 with a rigid hook 94 that is identical to the rigid hook 86 of the prior embodiment. The rigid hook 94 is bonded to a flexible substrate 96. The flexible substrate 96 is bonded to a PET layer 97, which is then bonded to the SEBS adhesive layer 98 with an adhesion promotor. The SEBS adhesive layer 98 is identical to the SEBS adhesive layer 88 of the prior embodiment. The SEBS adhesive layer 98 is mounted to the same support surface 90. The dual durometer hardware assembly 92 held up to four times the sheer force than that of the rigid mounted hardware assembly 84. Therefore, the flexible substrate 96 provides an improved bond between the rigid hook 94 and the support surface 90 than the hardware assembly 84 that omits the flexible substrate 96.

FIG. 18 illustrates a hardware assembly 102 according to another embodiment. The hardware assembly 102 includes a dry reversible adhesive layer 104 formed with a generally uniform thickness. A flexible substrate 106 is bonded to a PET layer 107, which is then bonded to the dry reversible adhesive layer 104 with an adhesion promoter. The flexible substrate 106 is formed from an elastomeric material. A rigid hardware component 108 is bonded to the flexible substrate 106. The rigid hardware component 108 is formed from a plastic material with a higher durometer than that of the flexible substrate 106. The flexible substrate 106 and the rigid hardware component 108 may be co-injection molded or coextruded to provide the bonding between the components 106, 108 and to simplify manufacturing.

The flexible substrate 106 may be formed from a translucent material. A light curable adhesive may be provided between the flexible substrate 106 and the SEBS adhesive layer 104. The translucency of the flexible substrate 106 permits light to pass through the substrate 106 to cure the adhesive and secure the bond of the substrate 106 to the dry reversible adhesive layer 104. The rigid hardware component 108 may also be formed from a translucent plastic to assist in curing the adhesive. The SEBS adhesive layer 104 may be flattened during the curing process to minimize curvature of the SEBS adhesive layer 104, and consequently to minimize nonconformance of the SEBS adhesive layer 104 at installation. A peel layer may be provided on the SEBS adhesive layer 104 on the surface that engages a support surface to protect the SEBS adhesive layer 104 until installation.

The rigid hardware component 108 is formed as a pair of opposed hooks. The hooks may be vertically symmetrical so that the user may install the hardware assembly 102 in either upright orientation. Alternatively, different sized hooks may be formed on either size to provide options to the user.

FIG. 19 illustrates another hardware assembly 110 according to an embodiment. The hardware assembly 110 includes a dry reversible adhesive layer 112 with a flexible substrate 114 bonded to a PET layer 115, which is then bonded to the dry reversible adhesive layer 112. The flexible substrate 114 is formed from an elastomeric material with a convex contour. A rigid hardware component 116 is bonded to the flexible substrate 114. The rigid hardware component 116 is formed from a plastic material with a higher durometer than that of the flexible substrate 114. The rigid hardware component 116 is formed with a contour shaped to mate with the flexible substrate 114 to enhance a bonded connection of the rigid hardware component 116 to the flexible substrate 114. The rigid hardware component 116 may also be formed with a pair of opposed hooks.

FIG. 20 illustrates another hardware assembly 118 according to an embodiment. The hardware assembly 118 includes a dry reversible adhesive layer 120 with a flexible substrate 122 bonded to a PET layer 123, which is then bonded to the dry reversible adhesive layer 120. The flexible substrate 122 is formed from an elastomeric material with a dual convex contour with an intermediate concavity. A rigid hardware component 124 is bonded to the flexible substrate 122. The rigid hardware component 124 is formed from a plastic material with a higher durometer than that of the flexible substrate 122. The rigid hardware component 124 is formed with a contour shaped to mate with the flexible substrate 122 to enhance a bonded connection of the rigid hardware component 124 to the flexible substrate 122. The rigid hardware component 124 may also be formed with a pair of opposed hooks.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A hardware assembly comprising:
a rigid hardware component;
a flexible substrate mounted to the rigid hardware component; and
a reversible dry adhesive spread across an application surface of the flexible substrate to mount the hardware assembly to a support surface, whereby the flexible substrate permits compliance between the reversible dry adhesive and the rigid hardware component to minimize nonconformance of the reversible dry adhesive upon the support surface.

2. The hardware assembly of claim 1 further comprising a flexible intermediate layer provided between the flexible substrate and the reversible dry adhesive, wherein the flexible substrate is bonded to the flexible intermediate layer, and the flexible intermediate layer provides the application surface of the flexible substrate.

3. The hardware assembly of claim 2 wherein the flexible intermediate layer is formed from polyethylene terephthalate.

4. The hardware assembly of claim 1 wherein the reversible dry adhesive comprises styrene ethylene butylene styrene.

5. The hardware assembly of claim 1 wherein the reversible dry adhesive comprises silicone.

6. The hardware assembly of claim 1 wherein the flexible substrate is formed from an elastomeric material.

7. The hardware assembly of claim 1 wherein the rigid hardware component is formed from a polymeric material.

8. The hardware assembly of claim 7 wherein the flexible substrate is formed from a polymeric material with a lower durometer than a durometer of the rigid hardware component.

9. The hardware assembly of claim 1 wherein the rigid hardware component comprises at least one hook.

10. The hardware assembly of claim 1 wherein the flexible substrate does not have a uniform thickness.

11. The hardware assembly of claim 10 wherein the flexible substrate and the rigid hardware component have mating surfaces that are shaped to enhance a bonded connection of the rigid hardware component to the flexible substrate.

12. A method of manufacturing a hardware assembly comprising:
forming a flexible substrate;
forming a rigid hardware component upon the flexible substrate; and
providing a reversible dry adhesive across an application surface of the flexible substrate.

13. The method of manufacturing the hardware assembly of claim 12 further comprising coextruding the flexible substrate and the rigid hardware component.

14. The method of manufacturing the hardware assembly of claim 12 further comprising co-injection molding the flexible substrate and the rigid hardware component.

15. The method of manufacturing the hardware assembly of claim 12 further comprising:
forming a flexible intermediate layer provided between the flexible substrate and the reversible dry adhesive to provide the application surface of the flexible substrate.

16. The method of manufacturing the hardware assembly of claim 15 further comprising dispensing a light curable adhesive between the flexible substrate and the flexible intermediate layer.

17. The method of manufacturing the hardware assembly of claim 16 further comprising:
forming the flexible substrate of a translucent material; and
conveying light to the hardware assembly to pass through the flexible substrate and to cure the light curable adhesive.

18. The method of manufacturing the hardware assembly of claim 17 further comprising:
forming the rigid hardware component of a translucent material; and
conveying light to the hardware assembly to pass through the rigid hardware component and to cure the light curable adhesive.

19. The method of manufacturing the hardware assembly of claim 16 further comprising flattening the reversible dry adhesive while curing the light curable adhesive to minimize nonconformance of the reversible dry adhesive at installation.

20. A method of installing a hardware assembly comprising:
providing a flexible substrate with a rigid hardware component upon one side of the flexible substrate, and a reversible dry adhesive upon another side of the flexible substrate; and
pressing the rigid hardware component towards a support surface to engage the reversible dry adhesive with the support surface while deforming the flexible substrate to minimize nonconformance of the reversible dry adhesive and the support surface.
